(19) United States
(12) Patent Application Publication
(10) Pub. No.: US 2014/0093844 A1
(43) Pub. Date: Apr. 3, 2014

(54) METHOD FOR IDENTIFICATION OF FOOD INGREDIENTS IN MULTIMEDIA CONTENT

(71) Applicant: CORTICA, LTD., Ramat Gan (IL)

(72) Inventors: Igal Raichelgauz, Ramat Gan (IL); Karina Ordinaev, Ramat Gan (IL); Yehoshua Y. Zeevi, Haifa (IL)

(73) Assignee: CORTICA, LTD., Ramat Gan (IL)

(21) Appl. No.: 14/096,865

(22) Filed: Dec. 4, 2013

Related U.S. Application Data
(63) Continuation-in-part of application No. 13/624,397, filed on Sep. 21, 2012.
Application No. 13/624,397 is a continuation-in-part of application No. 13/344,400, filed on Jan. 5, 2012.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 61/890,251, filed on Oct. 13, 2013.

(30) Foreign Application Priority Data
Oct. 26, 2005 (IL) 171577
Jan. 29, 2006 (IL) 173409
Aug. 21, 2007 (IL) 185414

(51) Int. Cl. G09B 19/00

(52) U.S. Cl. CPC G09B 19/0092
USPC 434/127

(57) ABSTRACT

A method for identifying nutritional data related to food substances contained in a multimedia content item is provided. The method includes analyzing a received multimedia content item to identify multimedia elements containing food substance; generating at least one signature for each identified multimedia element; querying a deep-content-classification (DCC) system for each of the identified multimedia elements to find at least one concept that matches at least one of the identified multimedia elements; matching the at least one signature of each of the at least one matching concepts to previously generated signatures of food substances maintained in a data warehouse; retrieving, for each of the at least one matching signature, nutritional data associated with the at least one matching signature from the data warehouse, thereby providing nutritional data for the food substances substance contained in the received multimedia content item; and sending the nutritional data to the user device.

### CROSS-REFERENCE TO RELATED APPLICATIONS

This application claims the benefit of U.S. provisional application No. 61/890,251 filed Oct. 13, 2013 and also is a continuation-in-part (CIP) of U.S. patent application Ser. No. 13/624,397 filed on Sep. 21, 2012, now pending. The Ser. No. 13/624,397 application is a CIP of:

(a) U.S. patent application Ser. No. 13/344,400 filed on Jan. 5, 2012, now pending, which is a continuation of U.S. patent application Ser. No. 12/434,221, filed May 1, 2009, now U.S. Pat. No. 8,112,376;

(b) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,

(c) U.S. patent application Ser. No. 12/084,150 having a filing date of Apr. 7, 2009, now allowed, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006.

All of the applications referenced above are herein incorporated by reference for all that they contain.

### TECHNICAL FIELD

The present invention relates generally to the analysis of multimedia content, and more specifically to a method for identifying characteristics of ingredients in food substances appearing in multimedia content items.

### BACKGROUND

The World Wide Web (WWW) contains a variety of information associated with food. Such information is commonly used by cooks, nutritionists, athletes, people with food-related diseases (e.g. diabetics, celiac patients), and other people interested in nutrition data. Such people commonly use a variety of web platforms to gain knowledge about the nutrition data of food they consume. The nutrition data (or facts) can be used, for example, to keep track of one's diet via counting calories or noting sugar or fat content of meals among other things.

Currently, many web platforms such as websites, web applications, and mobile applications (Apps), are designed to provide information related to nutrition facts of certain food products. For example, there is a solution for tracking how many calories that a user consumes by eating different types and portions of food. That solution displays the amount of calories, proteins, fat, and so on from the nutrition facts label on the sides of food packaging. That is, if a user eats a bowl of cereal, then the user would seek the nutrition facts as printed on the cereal box. The user in some solutions should take a picture of the cereal's barcode or the nutritional facts to gain the nutritional facts. However, if the user deviates from eating the food alone, i.e., by eating the cereal with milk and fruit added in, the existing solutions typically will not be capable of factoring in these additional ingredients so as to provide more meaningful nutrition information. Thus, the methods used to track relevant nutritional data by existing solutions may not be optimal.

As another example, a user may decide to eat a dish of pasta, but would first want to know if it contains allergen food ingredients. The user may use currently available solutions to track the nutritional facts that are related to the pasta and its possible sauces. However, such information cannot guarantee that the specific dish of pasta the user desires to eat does not contain allergen food ingredients. That is, with existing methods, when a dish is not accompanied by its packaging, it becomes increasingly difficult to accurately determine the nutrition and allergen characteristics of the ingredients of that particular dish.

It would therefore be advantageous to provide a solution that would overcome the deficiencies of the prior art by identifying the food ingredients of a specific food substance without requiring access to that food's packaging or nutrition facts label. It would further be advantageous to provide a nutrition data that may be specific to the identified food ingredient and/or a user's interests.

### SUMMARY

Certain embodiments disclosed herein include a method and system for identifying nutritional data related to food substances contained in a multimedia content item. The method comprises receiving from a user device at least one multimedia content item containing food substances; analyzing the at least one multimedia content item to identify one or more multimedia elements containing at least one food substance; generating at least one signature for each of the one or more identified multimedia elements; querying a deep-content-classification (DCC) system for each of the identified one or more multimedia elements to find at least one concept that matches at least one of the one or more identified multimedia elements, wherein the querying of the DCC system is performed using the at least one signature generated for each of the one or more multimedia elements; matching the at least one signature of each of the at least one matching concepts to previously generated signatures of food substances maintained in a data warehouse; retrieving, for each of the at least one matching signature, nutritional data associated with the at least one matching signature from the data warehouse, thereby providing nutritional data for the food substances substance contained in the received multimedia content item; and sending the nutritional data to the user device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to describe the various embodiments disclosed herein;

FIG. 2 is a flowchart describing the process of providing nutrition data related to food ingredients according to one embodiment;

FIG. 3 is a block diagram depicting the basic flow of information in the signature generator system; and

FIG. 4 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein include a method for identifying the food ingredients of a food substance in a multimedia content item. The multimedia content item in which the food substance is shown is received from a user device. At least one signature is generated for the food substance and the generated signature(s) are matched to at least one previously generated signature maintained in a data warehouse. One or more ingredients of the food substance are identified based on matching at least one newly generated signature to at least one previously generated signature. Accordingly, nutrition data respective to the food ingredient(s) is extracted from the data warehouse and sent to the user device. The nutrition data may include nutritional values, recipes, articles about related food ingredients, etc.

In an embodiment, the food substances in the multimedia content item can be identified based on identification of concepts. In another embodiment, the nutrition data sent to the user device may be in accordance with one or more of the user's nutrition preferences. As an example, when a user prefers a certain type of diet (for example, the Simmons diet), the nutrition data provided to the user may be optimized to that specific type of diet. Accordingly, the user receives information appropriate to that diet's requirements.

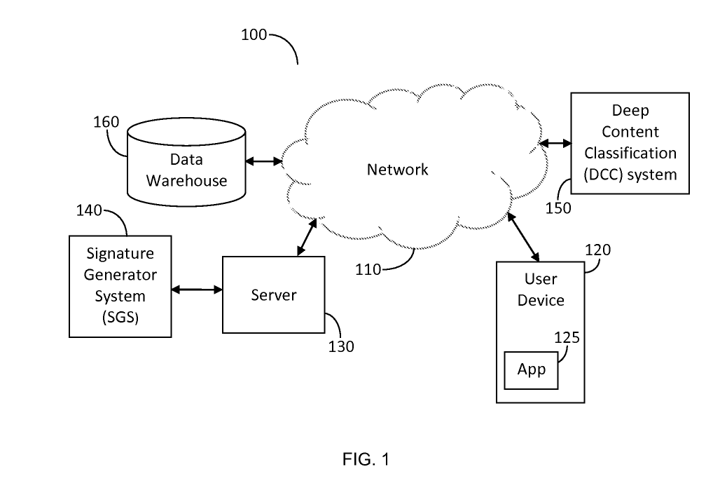

FIG. 1 shows an exemplary and non-limiting schematic diagram of a network system 100 utilized to describe the various embodiments disclosed herein. A network 110 is used to communicate between different parts of the network system 100. The network 110 may be the Internet, the world-wide-web (WWW), a local area network (LAN), a wide area network (WAN), a metro area network (MAN), and other networks capable of enabling communication between the elements of the system 100.

Further connected to the network 110 is a user device 120 configured to execute at least one application 125. The application 125 may be, for example, a web browser, a script, or any application programmed to interact with a server 130. The user device 120 may be, but not limited to, a personal computer (PC), a personal digital assistant (PDA), a mobile phone, a smart phone, a tablet computer, a laptop, a wearable computing device, or another kind of computing device equipped with browsing, viewing, listening, filtering, and managing capabilities that is enabled as further discussed herein below. It should be noted that the one user device 120 and one application 125 are illustrated in FIG. 1 only for the sake of simplicity and without limitation on the generality of the disclosed embodiments.

The network system 100 also includes a data warehouse 160 configured to store at least one multimedia content item in which a food substance(s) is shown, previously generated signatures of food ingredients/substances, a nutrition data related to certain food ingredients, and the like. In the embodiment illustrated in FIG. 1, the server 130 communicates with the data warehouse 160 through the network 110. In other non-limiting configurations, the server 130 is directly connected to the data warehouse 160.

The various embodiments disclosed herein are realized using the server 130, a signature generator system (SGS) 140 and a deep-content-classification (DCC) system 150. The SGS 140 may be connected to the server 130 directly or through the network 110. The server 130 is configured to receive and serve the at least one multimedia content item in which food substances are shown and cause the SGS 140 to generate at least one signature respective thereof and query the DCC system 150. To this end, the server 130 is communicatively connected to the SGS 140 and the DCC system 150.

The DCC system 150 is configured to generate concept structures (or concepts) and to identify concepts that match the multimedia content item. A concept is a collection of signatures representing a multimedia element and metadata describing the concept. The collection is a signature reduced cluster generated by inter-matching the signatures generated for the many multimedia elements, clustering the inter-matched signatures, and providing a reduced cluster set of such clusters. As a non-limiting example, a ‘Superman concept’ is a signature reduced cluster of signatures describing elements (such as multimedia elements) related to, e.g., a Superman cartoon: a set of metadata including textual representations of the Superman concept.

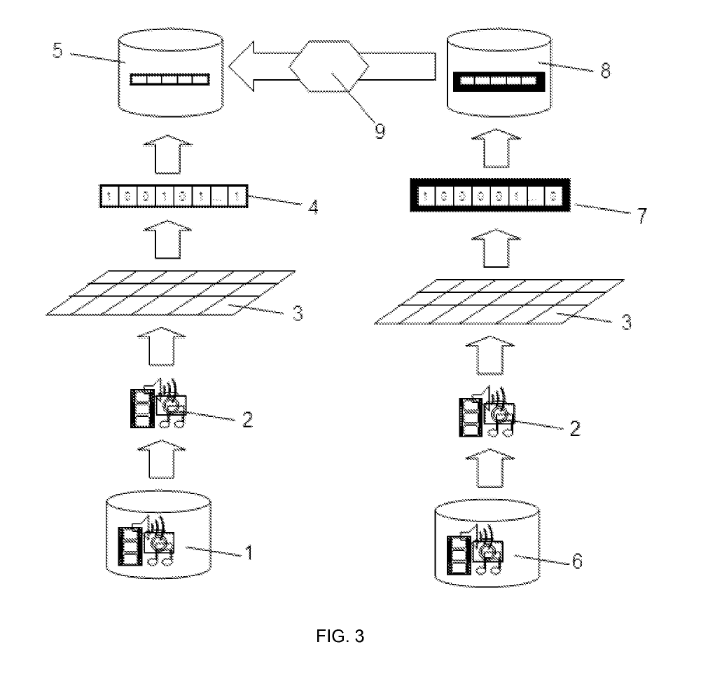

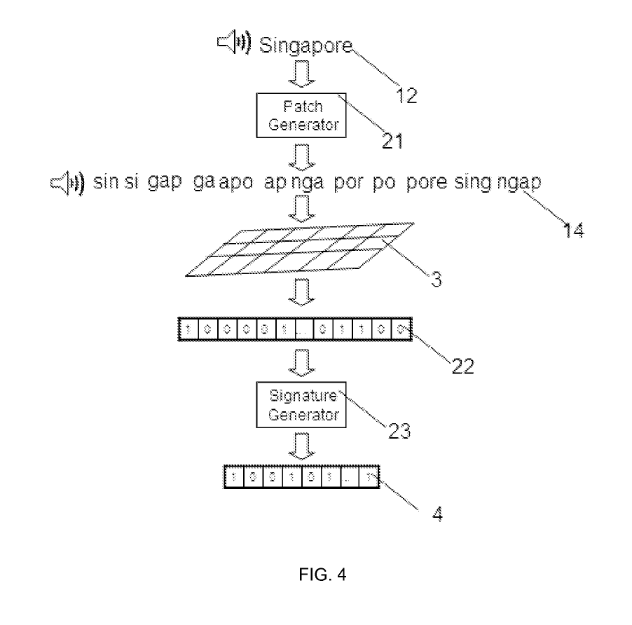

Techniques for generating concepts and concept structures are also described in the U.S. Pat. No. 8,266,185 (hereinafter the '185 Patent) to Raichelgauz, et al., which is assigned to a common assignee, and is incorporated by reference herein for all that it contains. In an embodiment, the DCC system 150 is configured and operates as the DCC system discussed in the '185 patent. The process of generating the signatures in the SGS 140 is explained in more detail below with respect to FIGS. 3 and 4.

It should be noted that each of the server 130, the SGS 140, and DCC system 150 typically comprise a processing unit, such as a processor (not shown) or an array of a processor coupled to a memory. In one embodiment, the processing unit may be realized through architecture of computational cores described in detail below. The memory contains instructions that can be executed by the processing unit. The server 130 also includes an interface (not shown) to the network 110.

According to the disclosed embodiments, the server 130 is configured to receive a multimedia content item showing food substances from the user device 120. The multimedia content item may be, but is not limited to, an image, a graphic, a video stream, a video clip, a video frame, a photograph, and/or combinations thereof and portions thereof. In one embodiment, the server 130 receives a URL of a web-page viewed by the user device 120 and accessed by the application 125. The web-page is processed to extract the multimedia content item contained therein. The request to analyze the multimedia content item can be sent by a script executed in the web-page such as the application 125 (e.g., a web server or a publisher server) when requested to upload one or more multimedia content items to the web-page. Such a request may include a URL of the web-page or a copy of the web-page. The application 125 can also send a picture or a video clip taken by a user of the user device 120 to the server 130.

The server 130, in response to receiving the multimedia content item, is configured to return at least nutrition data of the food substance shown in the displayed item. To this end, the server 130 analyzes the multimedia content item to identify portions or multimedia elements in the multimedia content item containing the food substances. As an example, consider a picture showing a pizza slice and a pizza box. For purposes of gathering nutritional data, only the pizza slice multimedia element is relevant. At least one signature is generated for each relevant multimedia element (i.e., an element that contains food substances) using the SGS 140. The generated signature(s) may be robust to noise and distortion as discussed below.

In one embodiment, using the generated signature(s), the DCC system 150 is queried to determine if there is a match to at least one concept of food. The DCC system 150 returns for each matching concept a concept's signature (signature reduced cluster (SRC)) and optionally the concept's metadata. Using the SRC of the matching concept, the server 130 is configured to determine the food ingredients of the food substances associated with the matching concept. Specifically, when one match is identified, the server 130 is configured to retrieve from the data warehouse 160 and send nutrition data associated with the food ingredients to the user device 120. The server 130 is configured to also search for the nutrition data in the warehouse 160 using the metadata.

In another embodiment, the SGS 140 generates signatures for the received multimedia content item or each relevant multimedia element identified therein. The generated signatures are matched by the server 130 to previously generated signatures of food substances stored in the data warehouse 160 to determine the food ingredients of the food substances shown in the multimedia content item. When at least one match is identified, the server 130 is configured to retrieve nutrition data related to those food ingredients from the data warehouse 160. The nutrition data is then sent to the user device 120.

In yet another embodiment, the server 130 is configured to receive from the user device 120 operated by a user, one or more inputs related to the user's nutrition preferences. The server 130 is further configured to analyze the inputs and provide the user of the user device 120 with nutrition data respective thereof. As an example, the user may prefer to receive recipes with beneficial nutritional qualities (recipes that contain omega-3, iron, calcium, etc.). As another example, celiac patients would prefer to receive a notification upon identification of dough in their food.

In yet another embodiment, the server 130 is further configured to receive information about an amount of the food substance from the user via the user device 120. The server 130 is further configured to analyze the inputs and provide the user of the user device 120 with the total nutrition data respective to that amount of the particular food substance at hand. As an example, a user may wish to know the nutrition data about a glass of a beverage (e.g., containing 10 fluid ounces of the beverage) containing more than one serving of juice (where a serving size may be, e.g., 8 fluid ounces of the beverage). The user may provide the server 130 with information about the total amount of beverage (in this particular example, 10 fluid ounces), and the server 130 returns the nutrition data corresponding to this amount of the beverage rather than nutrition data corresponding to the serving size of the beverage (in this particular example, 8 fluid ounces).

As a non-limiting example, when the server 130 receives an image of a “Greek salad,” signatures and/or matching concepts corresponding to each of the salad ingredients (e.g., tomatoes, olives, onion slices, crumbled feta cheese, and so on) shown in the image are generated. The nutritional values may be sent separately to the user by ingredient (e.g., providing the nutritional values pertinent to each of the tomatoes, olives, onion slices, crumbled feta cheese, and so on in a “Greek salad” separately), or by including the sum of each nutritional value (e.g., protein, sodium, etc.).

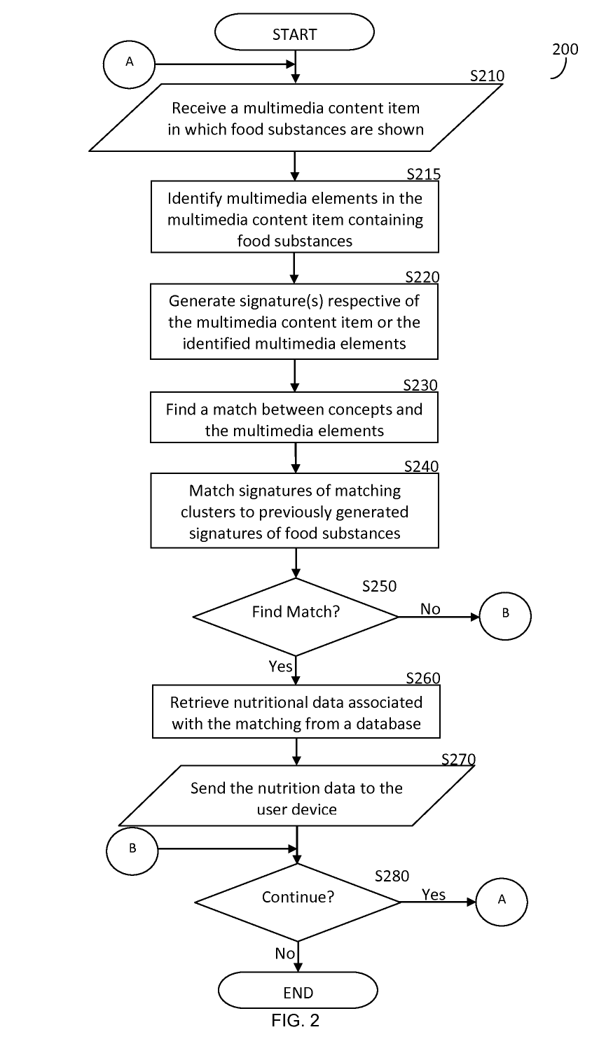

FIG. 2 depicts an exemplary and non-limiting flowchart 200 describing a method for providing nutritional data of food substances shown in multimedia content items according to an embodiment. The method may be performed by the server 130.

In S210, a multimedia content item in which food substances are shown is received. In an embodiment, the multimedia content item is received together with the user's nutrition preferences with respect to a user's diet or type of nutritional data the user is interested with.

Optionally, in S215, the received multimedia content item is analyzed to identify multimedia elements that contain food substances. In S220 at least one signature for the received multimedia content item or the multimedia element(s) is generated to include food substances. The signatures are generated by the SGS 140 as described in greater detail below with respect to FIGS. 3 and 4.

In S230, the DCC system (e.g., system 150) is queried to find a match between at least one concept and the multimedia elements using their respective signatures. In an embodiment, at least one signature generated for a multimedia element is matched against the signature (signature reduced cluster (SRC)) of each concept maintained by the DCC system 150. If the signature of the concept overlaps with the signature of the multimedia element (or multimedia content item) more than a predetermined threshold level, a match exists. Various techniques for determining matching concepts are discussed in the '185 Patent. For each matching concept the respective multimedia element is determined to be identified and at least the concept signature (SRC) is returned.

In S240, the server 130 is configured to match signatures of matching clusters to previously generated signatures of food substances/ingredients maintained in a database, such as the data warehouse 160. In another embodiment, if matching concepts are not found, the signatures generated at S220, are utilized to search the data warehouse 160.

In S250, the system checks whether a match can be found in the data warehouse 160 and, if so, execution continues with S260; otherwise, execution continues with S280. In S260, the nutritional data associated with each matching signature is retrieved from the data warehouse 160. The nutritional data includes the food ingredients of the food substances shown in the multimedia content item. Such nutritional data may be, but is not limited to, nutritional values, recipes, studies related to the food ingredients of the food substances, and so on. In S270, the nutritional data is sent to the user device 120. In S280, it is checked whether additional multimedia content items are received, and if so, execution continues with S210; otherwise, execution terminates.

As a non-limiting example, an image of a piece of sushi is received by the server 130 and signatures are generated by the SGS 140 respective thereto. The generated signatures are matched to at least one previously generated signature of food ingredients maintained in the data warehouse 160. Respective thereto, rice, seaweed, avocado, and salmon are identified as food ingredients shown in the multimedia content element. Then, nutritional data associated with each one of the food ingredients is retrieved from the data warehouse 160. In an embodiment, the nutrition values of the pieces of sushi are sent to the user by combining the values of the respective ingredients. It should be noted that the analysis of the image includes analysis of the signatures and concepts related to the image. This allows distinct identification of different pieces of sushi shown in the image and the ability to provide nutritional data for each of the different pieces of sushi.

It also should be noted that using the signatures and the concepts for searching for the nutritional data of food ingredients of a food substance ensures more accurate reorganization than, for example, using metadata alone. For instance, an image of a bowl of cereal topped with strawberry and banana pieces provides a more accurate representation of the food substances than a cereal box alone would. In most cases only the cereal would be designated in the metadata associated with the image. However, an analysis of the image and identification of various multimedia elements using the generated signatures would enable accurate recognition of each the food ingredients (cereal, milk, strawberries, and banana pieces) in the image, thereby providing accurate nutritional data of the food substance shown in the image.

FIGS. 3 and 4 illustrate the generation of signatures for the multimedia content elements by the SGS 140 according to one embodiment. An exemplary high-level description of the process for large scale matching is depicted in FIG. 3. In this example, the matching is conducted based on video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the generation of computational Cores are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing dynamics in-between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P, and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame T is injected into all the Cores 3. Then, Cores 3 generate two binary response vectors: \vec{S}, which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = • ( Vi - {Th}_{x} )$$

where, ␣ is a Heaviside step function; wᵢⱼ is a coupling node unit (CNU) between node i and image component j (for example, grayscale value of a certain pixel j); kⱼ is an image component ‘j’ (for example, grayscale value of a certain pixel j); Th_{X} is a constant Threshold value, where ‘x’ is ‘S’ for Signature and ‘RS’ for Robust Signature; and Vi is a Coupling Node Value.

The Threshold values Th_{X} are set differently for Signature generation than for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

For: Vᵢ>Th_{RS}

1−p(V>Th_{S})−1−(1−ε)ⁱ<<1 1:

i.e., given that l nodes (cores) constitute a Robust Signature of a certain image I, the probability that not all of these I nodes will belong to the Signature of same, but noisy image, \tilde{—} is sufficiently low (according to a system's specified accuracy).

p(Vᵢ>Th_{RS})≈l/L 2:

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need for comparison to the original data. The detailed description of the Signature generation can be found in U.S. Pat. Nos. 8,326,775 and 8,312,031, assigned to common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases, a core represents a dynamic system, such as in state space, phase space, edge of chaos, etc., which is uniquely used herein to exploit its maximal computational power.

(c) The Cores should be optimally designed with regard to invariance to a set of signal distortions, of interest in relevant applications.

A detailed description of the Computational Core generation and the process for configuring such cores is discussed in more detail in the co-pending U.S. patent application Ser. No. 12/084,150 referenced above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying nutritional data related to food substances contained in a multimedia content item, comprising:
receiving from a user device at least one multimedia content item containing food substances;
analyzing the at least one multimedia content item to identify one or more multimedia elements containing at least one food substance;
generating at least one signature for each of the one or more identified multimedia elements;
querying a deep-content-classification (DCC) system for each of the identified one or more multimedia elements to find at least one concept that matches at least one of the one or more identified multimedia elements, wherein the querying of the DCC system is performed using the at least one signature generated for each of the one or more multimedia elements;
matching the at least one signature of each of the at least one matching concepts to previously generated signatures of food substances maintained in a data warehouse;
retrieving, for each of the at least one matching signature, nutritional data associated with the at least one matching signature from the data warehouse, thereby providing nutritional data for the food substances substance contained in the received multimedia content item; and
sending the nutritional data to the user device.

2. The method of claim 1, wherein the data warehouse is configured to maintain any one of: multimedia content items, previously generated signatures of respective food ingredients and food substances, and nutritional data related to food ingredients and food substances.

3. The method of claim 1, wherein the nutritional data is at least one of: nutritional values, recipes, and studies related to food.

4. The method of claim 1, wherein the at least one generated signature is robust to noise and distortion.

5. The method of claim 1, wherein the at least one multimedia content item is any of: an image, a graphic, a video stream, a video clip, a video frame, and a photograph.

6. The method of claim 1, further comprising:
receiving nutrition preferences of a user of the user device with respect to at least a diet;
optimizing the nutritional data to meet at least the user's diet according to predetermined dietary considerations respective to the at least a diet; and
sending the optimized nutritional data to the user device.

7. The method of claim 1, wherein the at least one matching concept is a collection of signatures representing a multimedia element and metadata describing the at least one concept, the collection is of a signature reduced cluster generated by inter-matching signatures generated for a plurality of multimedia elements, and the at least one matching concept is represented using at least one signature.

8. The method of claim 7, wherein the at least one concept is determined to match a multimedia element when the at least one signature of the concept matches at least one signature generated for the multimedia element over a predefined threshold.

9. The method of claim 7, wherein upon identification of at least one matching concept, the at least one signature of the at least one matching concept is returned.

10. A non-transitory computer readable medium having stored thereon instructions for causing one or more processing units to execute the method according to claim 1.

11. A system for identifying nutritional data related to food substances shown in a multimedia content item, comprising:
an interface to a network for receiving at least one multimedia content item;
a processor;
a memory connected to the processor, wherein the memory contains instructions that, when executed by the processor, configure the system to:
analyze the at least one multimedia content item to identify one or more multimedia elements containing at least one food substance;
query a deep-content-classification (DCC) system for each of the one or more identified multimedia elements to find at least one concept that matches one of the one or more multimedia elements, wherein the querying of the DCC system is performed using the at least one signature generated for each of the one or more multimedia elements;
match the at least one signature of each the at least one matching concept to previously generated signatures of food substances maintained in a data warehouse;
retrieve, for each of the at least one matching signature, nutritional data associated with the at least one matching signature from the data warehouse, thereby providing nutritional data for the food substances contained in the at least one received multimedia content item; and
send the nutritional data to the user device.

12. The system of claim 11, wherein the data warehouse is communicatively connected to the system and configured to maintain any one of: multimedia content items in which food substances are shown, previously generated signatures respective of food ingredients and food substances, and nutritional data related to food ingredients and food substances.

13. The system of claim 11, wherein the nutritional data is at least one of:
nutritional values, recipes, and studies related to food.

14. The system of claim 11, wherein the at least one generated signature is generated by a signature generator system (SGS) being communicatively connected to the system, wherein the at least one generated signature is robust to noise and distortion.

15. The system of claim 11, wherein at least one multimedia content item is any of: an image, a graphic, a video stream, a video clip, a video frame, and a photograph.

16. The system of claim 11, wherein the system is further configured to:
receive nutrition preferences of a user of the user device with respect to at least a diet;
optimize the nutritional data to meet at least the user's diet according to predetermined dietary considerations respective to the at least a diet; and
send the optimized nutrition data to the user device.

17. The system of claim 11, wherein the at least one matching concept is a collection of signatures representing a multimedia element and metadata describing the at least one matching concept, the collection is of a signature reduced cluster generated by inter-matching signatures generated for a plurality of multimedia elements, and the at least one matching concept is represented using at least one signature.

18. The system of claim 17, wherein the at least one matching concept is determined to match a multimedia element when the at least one signature of the at least one concept matches at least one signature generated for the multimedia element over a predefined threshold.

19. The system of claim 17, wherein upon identification of at least one matching concept the at least one signature of the at least one matching concept is returned.

20. The system of claim 17, wherein the DCC system is communicatively connected to the system.
